(19) United States
(12) Patent Application Publication
(10) Pub. No.: US 2006/0101084 A1
(43) Pub. Date: May 11, 2006

(54) Policy based data migration in a hierarchical data storage system

(75) Inventors: Gregory T. Kishi, Oro Valley, AZ (US); Mark A. Norman, Tucson, AZ (US); Jonathan W. Peake, Tucson, AZ (US)

Correspondence Address: John C. Kennel;IBM Corporation, Intellectual Property Law, 9000 South Rita Road, Tucson, AZ, 85744, US

(73) Assignee: International Business Machines Corporation

(21) Appl. No.: 10/972,929

(22) Filed: Oct. 25, 2004

(51) Int. Cl. G06F 17/30

(52) U.S. Cl. 707/200

(57) ABSTRACT

A hierarchical data storage system including a policy based migration engine to select a migration policy and migrate data from a first set of removable storage media, such as tape cartridges, to a second set of removable storage media in accordance with the migration policy. The hierarchical data storage system further includes a control unit including a processor, a host interface to couple the processor to a host, a library manager interface to couple the processor to an automated tape library, a storage device interface to couple said processor to a storage device, and a memory unit.

### BACKGROUND

1. Technical Field

The present invention relates generally to data storage and data processing. More specifically, the present invention relates to efficient data management within a hierarchical data storage system.

2. Description of the Related Art

In a hierarchical data storage system, fast-access storage devices are combined with arrays of relatively slower, less frequently accessed storage devices. As an example, frequently accessed data is generally stored on relatively expensive fast-access storage devices such as direct-access storage devices (DASD), while less frequently accessed data is generally stored on relatively less expensive, slower storage devices such as sequential-access storage media (e.g., tape media). The combination of storage devices in this way helps balance the costs of storing data with the speed at which the data must be accessed.

An example of a hierarchical storage system is a virtual tape storage system (VTS). Generally, a VTS is coupled to one or more host computers for the purpose of managing host data. A key function of the VTS is to provide long term storage of host data, while at the same time, provide relatively fast access to portions of that data. To accomplish this, a VTS typically includes a combination of slow access storage media such as tape cartridges for long term data storage, and storage media such as DASD, where portions of the data are “cached” for relatively fast access. Data which is to be stored long term is stored on tape cartridges, while data which may be frequently accessed is “cached” on the DASD.

In operation of a VTS, a host provides data to the VTS in the form of “volumes” (e.g., a volume may be a particular backup image of host data, archived data, data files, and the like). The VTS receives the volumes from the host and stores each volume on DASD for intermittent storage. A volume of data stored on DASD is referred to as a “virtual volume”. The VTS subsequently transfers the virtual volumes to tape cartridges. A volume of data stored on a tape cartridge is referred to as a “logical volume”. A number of logical volumes may be stored on a single tape cartridge. A cartridge that contains a number of logical volumes is referred to as a “stacked cartridge” since, conceptually, the multiple volumes are efficiently stacked end-to-end on the cartridge.

A typical VTS may contain thousands of stacked cartridges, many of which are of different formats so as to provide versatility within the VTS. As a method of managing the cartridges within a VTS, pooling may be used. As used herein, pools are logical groups of physical cartridges having common attributes. For example, one pool may logically group stacked cartridges of one specific tape format (e.g., 3590 media), another pool may be defined to logically group stacked cartridges of a different format (e.g., LTO media), and yet another pool may be defined to logically group unused or blank cartridges. By grouping the cartridges in this way, efficiencies can be gained by applications which depend on the properties of the cartridge. For example, examining the number of cartridges in a “blank pool” would indicate whether there are enough blank cartridges to accommodate the expected data storage needs of the VTS. Pools are typically embodied as data structures stored in memory of a VTS and include a list of the cartridges logically stored in each pool.

In addition to pooling, a process called “reclamation” is used to manage storage space on tape cartridges in a VTS. Generally, reclamation involves copying active data from a source cartridge to a destination cartridge and occurs when the active storage space on the source cartridge has reached some minimal threshold. Active data refers to data on a cartridge which the host has not expired. Inactive data on a cartridge refers to data which the host has expired. Data may be expired by a host when it is no longer needed or when the data has been superceded by an updated version of the data. A volume containing expired data is referred to as inactive data volume.

Over time, the amount of active data on a given cartridge may comprise only 10% of the total space on the cartridge, with the remaining 90% of the space comprising inactive data. The space consumed by the inactive data, however, is unusable and cannot be overwritten (this is because of the characteristics of tape media, once a tape is full of data, no additional data may be written to the tape). The inactive data space on a cartridge is typically spread throughout the cartridge, resulting in data space “holes” surrounded by active data. In order to reclaim the space consumed by the inactive data, the 10% of active data spread throughout the source cartridge is copied end-to-end to a destination cartridge, effectively squeezing out these “holes”. With only the active data now copied to another cartridge, the source cartridge is now available for storing data, and the source cartridge is said to have been “reclaimed”. As used herein, a “scratch cartridge” refers to a cartridge which has been reclaimed.

While known techniques of reclamation are available to manage storage efficiency, limitations exist. One limitation with respect to reclamation is that the implementation of reclamation is dependent upon the percentage of active data on a source cartridge falling below a predefined threshold. Thus, the only way to trigger the copying of data on a group of source cartridges to a group of destination cartridges is to examine the percentage of active data on a given source cartridge, and if it falls below a predefined threshold, mount the cartridge and migrate the data. This presents an efficiency problem in that not all data is expired by a host at the same rate or using the same criteria. This may result in a particular cartridge never falling below the specified threshold, yet have a relatively high percentage of inactive data. Since a VTS can contain thousands of tape cartridges, the percent of wasted space in a VTS can be significant.

Because of the amount of storage accessible within a VTS, as well as the different formats of storage, the efficient management of data and storage resources of a VTS is very challenging, even with the aid of pooling and reclamation. In addition to the limitations above, common difficulties associated with managing data in a VTS include efficient management of storage space on individual cartridges as well as accommodating for different cartridge formats within the VTS.

For example, a VTS may include a number of tape drives, each of which may require the use of a unique cartridge format. A difficulty arises if a user of the VTS wishes to consolidate all tape drives of VTS to a single tape drive format or to different formats. By consolidating to a single format, and/or switching to different formats, the user runs the risk of having a number of obsolete tape cartridges (e.g., not compatible with the new drive format). As a result, the data on the cartridges will be inaccessible, unless the data can be migrated to media compatible with the drives in the system. Unfortunately, there is no known way to efficiently migrate such data. A similar problem results for a user that desires to upgrade to a new drive format, which may require the use of new cartridges and migration of active data contained on incompatible cartridges.

These challenges and others are made more difficult for VTS systems which include thousands of tape cartridges. Unfortunately, known methods of migration require a user to identify, cartridge by cartridge, the source data to be migrated. This can be a time consuming, and often error-prone process. The down-time and errors may translate into real economic loss for a business relying on the accessibility and accuracy of the data. Additionally, known migration methods are limited in their ability to efficiently transfer data to one or more destination cartridges. The process typically involves manually identifying individual source cartridges one at a time, reading the data from the source cartridge and then writing the data to a destination cartridge. From all of the proceeding, it can be seen that there is a need for an efficient way to manage the data in a virtual tape server, including the management of data on cartridges, and the management of the cartridges themselves.

### SUMMARY

It has been discovered that by grouping tape cartridges into logical groups called pools, defining reclamation policies, and associating one or more of the reclamation policies with a particular pool, a process can be used to efficiently migrate data from one or more source cartridges to one or more destination cartridges, greatly improving the data management of a hierarchical storage system, such as a Virtual Tape Server (“VTS”). As used herein, migrating data can constitute copying data from a source to a destination if one or more conditions are satisfied. The present invention thus provides more storage space within the VTS, decreased cost associated with the management of the VTS and storage of data within the VTS, and improved efficiency in transferring data from one set of tape cartridges to another set of tape cartridges.

In one embodiment of the present invention, a method of migrating data from a first tape cartridge to a second tape cartridge is described. The method involves operations of obtaining a migration policy having a migration condition, determining whether at least one volume on the first tape cartridge satisfies the migration condition, and if so, copying the volume to a second tape cartridge. These operations are performed transparent to other applications. In another embodiment, the present invention may be implemented in a data storage system including a processor, a host interface coupled to the processor, and a memory unit coupled to the processor. The memory unit includes a storage management engine and a policy based migration engine. The policy based migration engine is configured to select a migration policy having a migration condition, and if data on a first removable storage media satisfies the migration condition, the data is migrated from the first removable storage media to a second removable storage media. In yet another embodiment, the invention may be implemented by a program of machine-readable instructions stored on a computer readable medium. The instructions are executable by a processor of a hierarchical data storage system to perform a method of migrating data from a first tape cartridge of the hierarchical data storage system to a second tape cartridge of the hierarchical data storage system as described herein.

### BRIEF DESCRIPTION OF THE DRAWINGS

For a better understanding of the invention, reference should be made to the following detailed description taken in conjunction with the accompanying drawings, in which:

FIG. 1 is a block diagram of a hierarchical data storage system including policy based migration in accordance with the present invention;

FIG. 2 is a computer utilized in implementing policy based migration in accordance with the present invention;

FIG. 3 is a flow chart illustrating a technique of defining migration policies in accordance with the present invention;

FIG. 4 is a flow chart illustrating a technique of policy based migration in accordance with the present invention;

FIG. 5 is a block diagram illustrating pools, cartridges and volumes of data; and

FIG. 6 is an exemplary database produced and used in accordance with the techniques of the present invention.

### DETAILED DESCRIPTION

Introduction

The management of tape cartridges in a Virtual Tape Server (“VTS”), and the data on such cartridges, is a challenging task. A VTS can contain thousands of tape cartridges, and the data on these tape cartridges must be efficiently spread across available resources. Within a VTS, it is often necessary to migrate data on the tape cartridges to other storage devices of the VTS to take advantage of the efficiencies provided by such other storage devices. Accordingly, the present invention groups tape cartridges into logical groups called pools and provides methods to efficiently transfer the data from one pool to another pool according to specific policies. This process is referred to herein as policy based migration. Depending on whether a given policy is satisfied, a reclamation process, for example, can be used to copy data from a source cartridge to a destination cartridge and reclaim the source cartridge. Using the reclamation process in this way provides a number of advantages, including the ability to operate on a group of cartridges via pools and the ability to execute the procedure with minimal impact to the VTS and/or any attached hosts (e.g., as a background process, at a time when no other resources need the system, transparent to the user and host applications, and the like). In so doing, more usable storage space within the VTS as well as decreased cost associated with the management of the VTS can be obtained. As used herein, “migration” is used to describe the copying data from a source cartridge to a destination cartridge for any number of reasons. For example, upgrading from an old tape format to a new tape format, transferring data to a format more tuned to the storage needs of the data, transferring data to lower cost media, and the like.

The following sets forth a detailed description of the best contemplated mode for carrying out the invention. The headings provided herein are intended to aid in the description of the present invention and are not intended to limit the scope of the present invention. The description herein is intended to be illustrative of the invention and should not be taken to be limiting.

An Exemplary Hierarchical Storage System

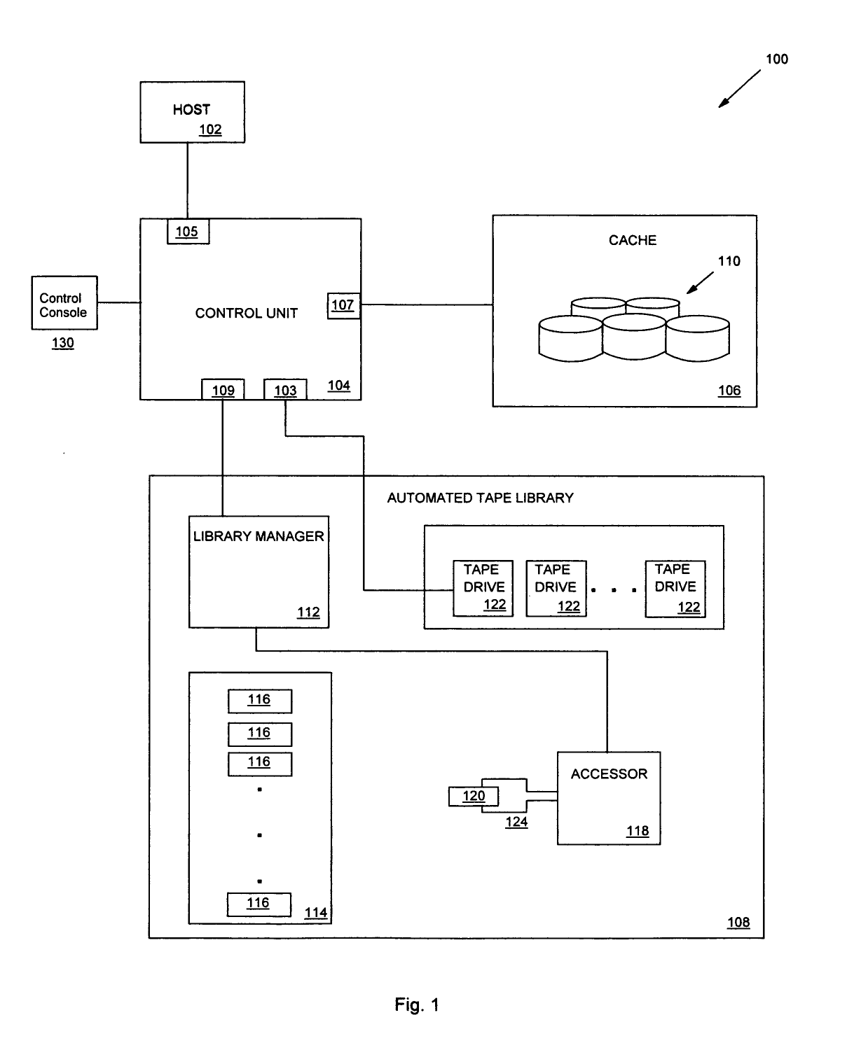

FIG. 1 illustrates hardware components, software components and interconnections of an exemplary hierarchical storage system 100 employing policy based migration in accordance with the present invention. Hierarchical storage system 100 includes one or more hosts 102, a control unit 104, a cache 106, and an automated tape library 108. Host 102 is coupled to control unit 104 via host interface 105. Cache 106 is coupled to control unit 104 via storage device interface 107. Automated tape library 108 is coupled to control unit 104 via library manager interface 109. Tape drives 122 are coupled to control unit 104 via drive interface 103. Interfaces 103, 105, 107, and 109 may each be SCSI, FICON, ESCON, Ethernet, TokenRing, serial, or other known communication interfaces.

In operation, host 102 stores data to and requests data from VTS 100. In an exemplary implementation, host 102 may be embodied as a server, network attached storage device, personal computer, terminal, application program and the like. Control unit 104 exchanges data between host 102 and cache 106, and between host 102 and library 108. The exchanges are conducted in accordance with commands from host 102, such as tape commands. Control unit 104 exchanges data between cache 106 and tape drives 122 in accordance with commands from the control unit 104. Control unit 104 may be implemented by the execution of software on a microprocessor (e.g., a RISC based processor, INTEL-based processor, or other instruction based processor). Control unit 104 and cache 106 may be embodied, for example, in an IBM model 3494 model B20 Virtual Tape Server.

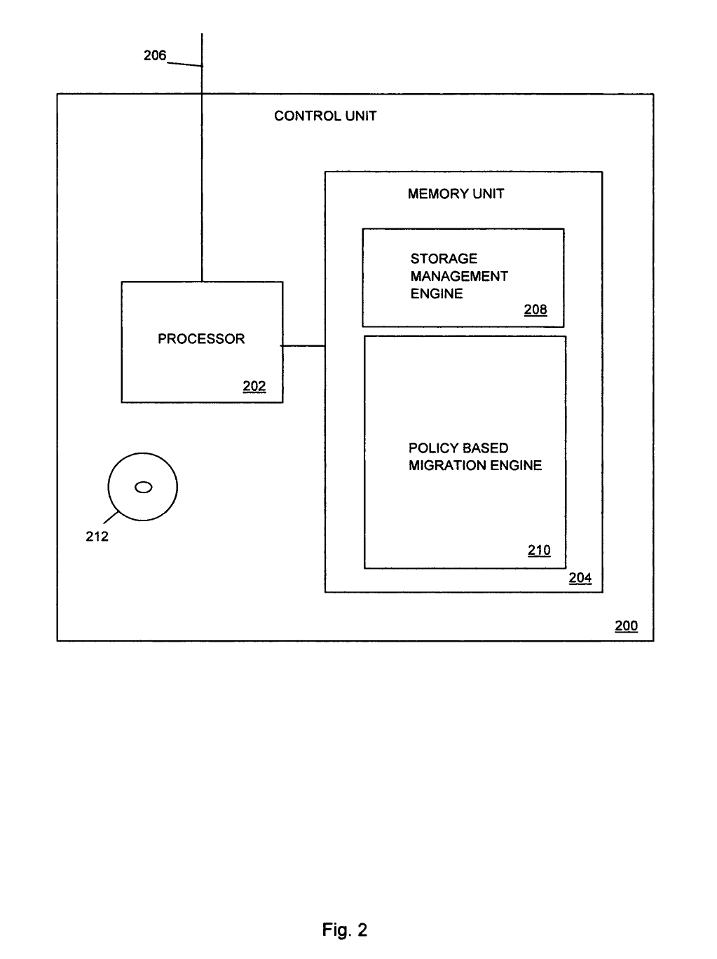

Control unit 104 directs operations of library manager 112. In one embodiment, control unit 104 receives commands from host 102 and, in turn, issues commands to library manager 112 to carry out the host commands. In response to such commands, data may be transferred between hosts 102 and cache 106, between host 102 and tape cartridges 120, and/or between cache 106 and tape cartridges 120. In the presently described embodiment, control unit 104 is implemented as computer 200 (shown and described in FIG. 2).

Cache 106 may comprise DASD 110 configured in one or more storage forms, such as redundant arrays of inexpensive disks (i.e., RAID). Cache 106 provides a fast-access data storage location for data utilized by host 102. In operation, host-created volumes of data are received from host 102 and “stacked” (i.e., stored) in cache 106. These volumes are then copied to physical tape cartridges 120 of tape library 108, either immediately (e.g., within fractions of a second), or upon some predetermined criteria, such as access frequency. In one embodiment, host 102 views (e.g., uses tape related protocols to communicate with) the storage space provided by cache 106 as a number of tape devices, when in actuality, the storage space is comprised of DASD. Because host 102 sees cache 106 as tape drives, host 102 can operate on data stored in cache 106 (and library 108) via tape commands. The interaction between host 102 and tape drives 122 of VTS 100 occurs through control unit 104.

Control console 130 is coupled to control unit 104 via serial, TokenRing, Ethernet, USB or other known communication interface. In one embodiment, control console 130 provides a user interface for setting up policies and monitoring the activities of the control unit 104 and the exemplary hierarchical storage system 100.

Automated tape library 108 comprises hardware, software, and interconnections to manage the storage of data on removable media. In the presently described embodiment, removable media consists of tape cartridges 120. However, in other embodiments removable media may consist of optical media and/or other media adapted to be removable within library 108. Tape cartridges 120 are stored in storage area 114, having storage bins 116. An accessor 118, having a robotic arm 124, selectively transfers tapes 120 to/from bins 116 from/to tape drives 122 for reading and writing of data on tapes 120 by tape drives 122 (accessor 118 with robotic are 124 may also be referred to as a gripper). One of ordinary skill in the art will recognize that accessor 118 and robotic arm 124 may be implemented any number of ways to provide a mechanical (or robotic) device to transport cartridges. In one exemplary implementation, library 108 may be embodied as an IBM 3494 tape library including IBM 3590, 3592 and/or LTO tape drives to access data on associated tapes. As mentioned above, library 108 includes library manager 112 to manage operations of library 108. In the presently described embodiment, library manager 112 is embodied as executable code stored on memory (not shown) of library 108 and configured to execute on one or more processors (not shown) of library 108.

Turning now to a more detailed description of control unit 104, FIG. 2 illustrates control 104 implemented as computer 200. Computer 200 includes a processor 202 coupled to a memory unit 204. In one embodiment, processor 202 is a RISC-based processor that interfaces with communication paths 206 between control unit 200 and the other elements of the exemplary hierarchical storage system 100. Such communication paths 206 may be ESCON/FICON, SCSI and the like. Additionally, processor 202 provides tape emulation to host 102 connected to the VTS such that hosts view cache 106 of the VTS as tape drives. While processor 202 is described as a RISC-based processor, processor 202 may be an INTEL based processor or other processor capable of performing the operations described herein.

Memory unit 204 may include a local cache or random access memory (not shown) and/or a nonvolatile memory (not shown). Memory unit 204 may be used to store programming instructions executed by processor 202. For example, memory unit 204 includes storage management engine 208 and policy based migration engine 210. In the presently described embodiment, each of storage management engine 208 and policy based migration engine 210 are implemented in software. Storage management engine 208 manages cache 106 and the volumes stored therein. In addition, storage management engine 208 controls the movement of data between cache 106 and tape cartridges 120. In one embodiment of the present invention, storage management engine 208 can be implemented by IBM's Tivoli Storage Manager.

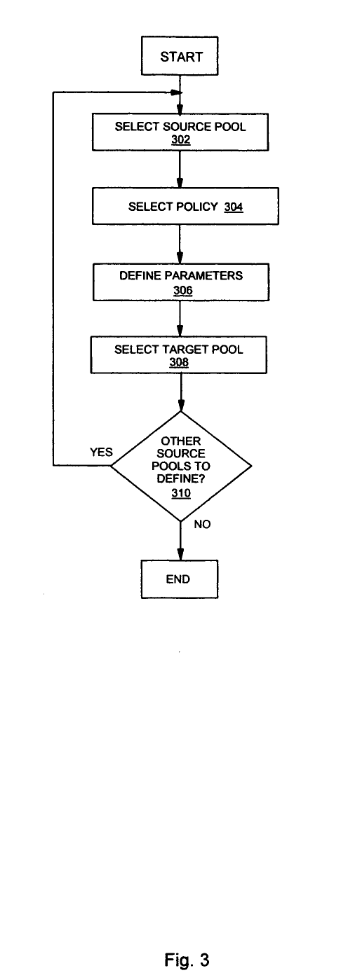

Policy based migration engine 210, which embodies techniques of the present invention in software form, provides techniques to efficiently manage data storage cartridges 120. As described above, a hierarchical data storage system such as system 100 may comprise thousands of tape cartridges of various formats storing various types of data. In such an environment, it becomes critical to be able to efficiently manage the storage provided by the tape cartridges as well as provide an efficient migration process to migrate data from the existing tape cartridges to newer and/or different formats of tape cartridges, for example. To address these needs, the present invention provides techniques to efficiently manage data on tape cartridges 120. These techniques, described in detail below with reference to FIGS. 3-5, provide the ability to migrate data of various cartridges based on dynamic policies using a reclamation process.

In the presently described embodiment, policy based migration engine 210 may be embodied in machine-readable instructions executed by processor 202. The machine-readable instructions may reside on a programmed product comprising signal-bearing media tangibly embodying a program of machine-readable instructions executable by processor 202 to perform method of computation, store or access data, and the like. The signal bearing media may comprise, for example, RAM of memory unit 204. Alternatively, the instructions may be stored in another signal-bearing media, such as ROM 212, diskette, magnetic storage device, optical storage device, or other signal-bearing media including transmission signals such as physical and/or wireless communication links. In the presently described embodiment, the machine readable instructions comprise C language code. It will be recognized that while storage management engine 208 and policy based migration engine 210 are described as implemented in software, each may also be implemented in hardware, a combination of software and hardware, or other compatible media capable of executing the techniques described herein.

One of ordinary skill in the art will recognize that computer 200 may be implemented in a computer having fewer or more components than computer 200. For example, all or part or memory unit 204 may be included on processor 202.

Exemplary Policy Based Migration

FIG. 3 illustrates a method for defining the policies to be used by policy based migration engine 210 in accordance with the present invention. In the exemplary embodiment, the reclamation policies are defined by a user, for example, through control console 130. In another embodiment, the reclamation policies are defined through commands received from host 102. In still another embodiment, the policies may be implemented by service of the VTS system. For example, a consulting business may have service responsibility for a number of customer systems, including a VTS system. The service responsibilities may include maintenance of the customer systems involving such tasks as system upgrades, error diagnostic, performance tuning and enhancement, installation of new hardware, installation of new software, configuration with other systems, and the like. As part of this service, or as a separate service, the service personnel may configure the VTS according to the techniques described herein so as to efficiently manage the data in the VTS system. For example, such a configuration would involve the loading into memory of computer instructions and proving parameters to the instructions, so when executed, carry out the techniques described herein. These computer instructions can be embodied in policy based migration engine 210. Additionally, the configuration of the VTS in accordance with the techniques described below may be facilitated though a user interface used in conjunction with policy based migration engine 210.

Initially in configuring a system for policy based migration, a source pool is selected on which the migration policy is to act (operation 302). The source pool is a logical group of cartridges that are to be reclaimed according to a defined migration policy. Next, a migration policy is selected (operation 304). The migration policy sets the criteria which triggers a reclamation process to initiate the copy of data from a source cartridge to a destination cartridge. In one embodiment of the present invention, the reclamation policies include one or more of a “percent of active data” policy, a “time since last access” policy, a “time since last data written” policy, and a “rate of expiration of data” policy.

The “percent of active data” policy is used to reclaim a cartridge when the amount of data on the active data volumes on a cartridge falls below a pre-defined percentage of the overall data on the cartridge when the cartridge was full. The “time since last access” policy is used to reclaim a cartridge when a pre-defined period of time has elapsed since data on the cartridge was accessed (data on a cartridge is accessed when a host requests the data associated with a volume, the cartridge containing the volume is loaded on a tape drive 122 and one or more data records are read from the cartridge). The “time since last data written” policy is used to reclaim a cartridge when a pre-defined period of time has elapsed since data was last written on the cartridge. The “rate of expiration of data” policy is used to reclaim cartridges when a pre-defined period of time has elapsed since a portion of the data on a cartridge became expired.

Following selection of one or more of the policies, parameters associated with the selected migration policy are defined (operation 306). For the “percent of active data” policy, a percentage is defined. For the “time since last access”, “time since last data written” and “rate of expiration of data” policies, a period of time is defined. That period of time can be in seconds, hours, days or another suitable measure of time. For the “rate of expiration of data” policy, a minimum percentage of active data on the volume can be defined as well.

Next, a target pool is defined (operation 308). The target pool consists of those cartridges which are to receive the active data volumes from the cartridges of the source pool when the migration policy is executed and necessary conditions are satisfied. If there are other source pools for which a migration policy is to be defined (decision block 310), the operations 302-308 are repeated. Otherwise, the definition of the reclamation policies is complete and reclamation evaluations may be performed by the policy based migration engine 210.

The evaluation of the reclamation policies may begin by many methods. It may be continuous once the policies have been established or be started based on other criteria. For example, the exemplary policy based migration engine 210 may perform evaluations for reclaimable cartridges periodically, such as an hourly basis, or when processing cycles are available for reclaim or when the number of available scratch cartridges falls below a threshold or other methods know to those skilled in the art. Using such a process, at periodic intervals, policy based migration engine 210 would evaluate each cartridge in a given pool to determine whether the migration conditions are satisfied. If the migration conditions were satisfied, policy based migration engine 210 would initiate the migration of data from that cartridge to a cartridge in the associated destination pool. The source cartridge would then be available as a scratch cartridge, and the process would continue for the remaining cartridges within the pool. This process is described in more detail below.

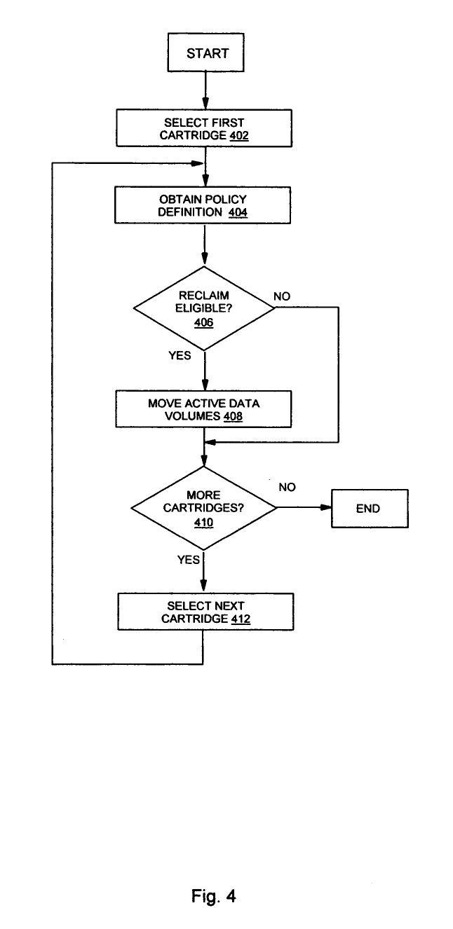

FIG. 4 illustrates, in general terms, operations performed by the preferred embodiment of the policy based migration engine 210 in accordance with the present invention. Policy based migration engine 210 increases the management efficiency of data within a hierarchical data storage system (e.g., system 100) by migrating data, according to defined reclamation policies, from a source cartridge to a destination cartridge more suited to the storage needs of the data. The migration policy sets the criteria which triggers a reclamation process to initiate a copy of data from a source cartridge to a destination cartridge.

Reclamation involves evaluating cartridges in an automated tape library 108 to determine if one or more cartridges in the library are eligible for reclaim. If a cartridge within the library is eligible for reclaim, the active data volumes of that cartridge are eligible to be copied to a destination cartridge within a target pool. Accordingly, in operation 402, a first tape cartridge within the library is selected and the migration policy defined for the pool the cartridge is obtained (operation 404). Next, the policy based migration engine 210 determines whether or not the cartridge is eligible for reclaim according to the obtained migration policy (decision block 406).

If the cartridge is eligible for reclaim, the process continues to operation 408, were the cartridge is reclaimed (“Yes” branch of decision block 406 and operation 408). In being reclaimed, all active data volumes are migrated from the source cartridge to a destination cartridge with available space in the target pool. The active data volumes are placed end to end, efficiently using the storage space on the cartridge in the target pool. Until the cartridge in the target pool becomes full, data from other reclaimed cartridges can be placed on it as well. When the cartridge has been reclaimed, the process continues to the other cartridges in the library not yet evaluated for reclaim, if any. (“Yes” branch of decision block 410, and operation 412). If, however, the cartridge is not eligible for reclaim, the process continues to check the other cartridges in the library, if any (“No” branch of decision block 406, “Yes” branch of decision block 410 and operation 412). Once all of the cartridges in the library have been checked for eligibility of reclamation (and reclaimed accordingly) (operations 404-412), the process ends. A more detailed description of each migration policy is now provided.

In one embodiment of the present invention, the cartridges selected for reclamation evaluation (operations 402 and 412) are selected alphanumerically by their volume serial number. Alternatively, all cartridge selection may occur on a pool by pool basis. Once cartridges in the first pool have been evaluated, cartridges from another pool can be selected for evaluation. Those skilled in the art will recognize that there are many possible criteria for selecting cartridges for evaluation without departing from the scope of the present invention.

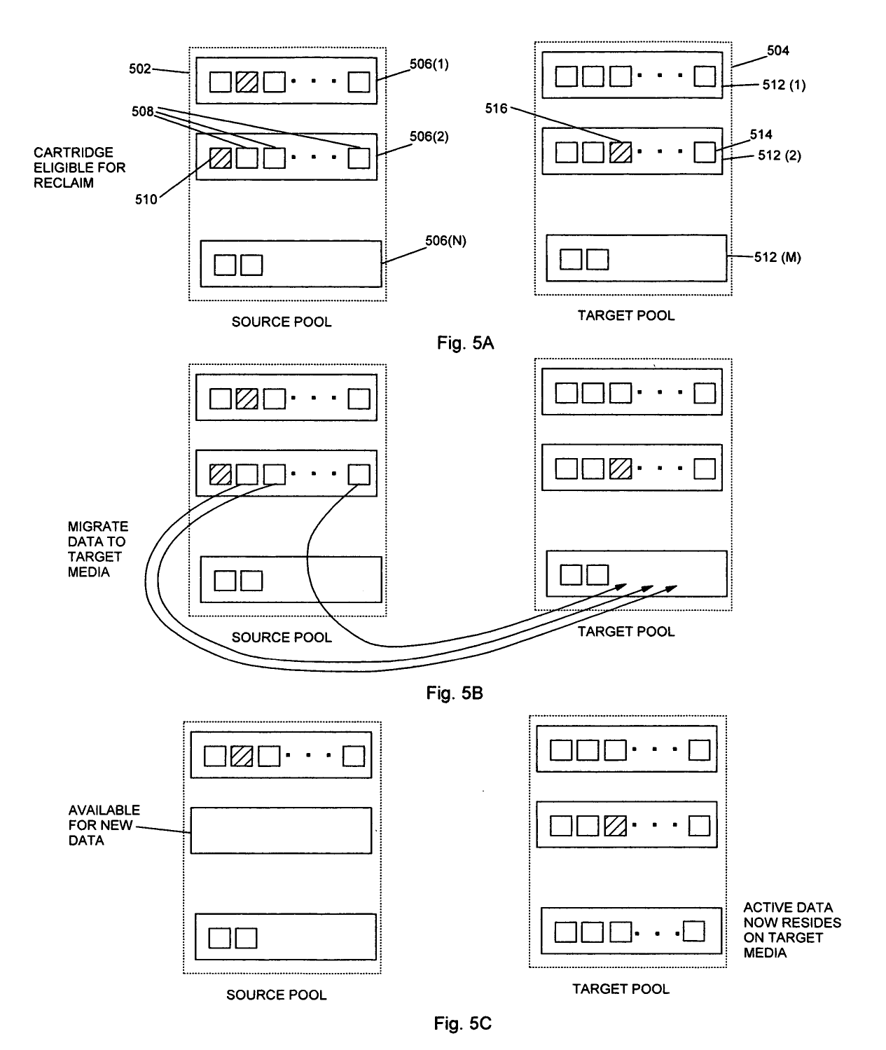

FIG. 5 is a diagram illustrating an exemplary pooling configuration and is used to aid in the description of the present invention. FIG. 5 includes pools 502 and 504. Pool 502 is a source pool, and includes cartridges 506 having stored thereon active data volumes 508 and inactive data volumes 510. Pool 504 is a target pool and includes cartridges 512 having stored thereon active data volumes 514 and inactive data volumes 516. In one embodiment, pools 502 and 504 are embodied as databases stored in memory unit 204 of computer 200, and the cartridges are included in storage bins or tape drives of hierarchical storage system 100. The cartridges of the pools may be identified in the database by any unique identifier, such as a serial number and volume number of the cartridge (referred to as a volser).

Percent of Active Data Migration policy

The “percent of active data” migration policy performed by policy based migration engine 210 is described with reference to FIG. 5. Not all data created by a host is kept for long periods of time. For example, data such as host backups may be stored only for as long as a set backup period and then replaced by a subsequent backup image. When data is no longer needed by the host, it is said to have been expired. In the exemplary hierarchical storage system 100, when the host expires data stored within the system, the space the expired data occupies on a cartridge is considered to be inactive space. As the host expires more and more of the data stored on a cartridge, the efficiency of the storage system degrades as more and more space on a cartridge contains inactive data. In addition, the data does not necessarily expire in the order that the data was stored on a cartridge (e.g., sequentially beginning from the first volume on the cartridge). Such an out of order expiration results in regions of active and inactive data volumes across the storage space of the cartridge. It is well known in the art that the inactive data space cannot be used to store new data due to the limitations of tape storage. Accordingly, the “percent of active data” migration policy is defined to be used to identify cartridges to be reclaimed when the amount of active data on a cartridge falls below a pre-defined threshold. In the process of reclaiming the cartridge, the active data volumes are moved to a target cartridge and placed contiguously on that cartridge, freeing up the source cartridge for reuse. For clarity of explanation, the “percent of active data” policy is explained in reference to FIGS. 4 and 5.

In operation, a “percent of active data” policy is defined for pool 502 and as part of that definition, pool 504 is defined as the target pool. In the presently described embodiment, source pool 502 and target pool 504 contain high capacity cartridges, for example cartridges capable of storing 60 GBs of data. In one embodiment of the present invention, pools 502 and 504 are defined with storage management software (e.g., storage management engine 208). In accordance with the present invention, a cartridge 506 is selected (operations 402 or 412) and the policy assigned for the cartridge is the “percent of active data” policy. Following this assignment, the policy based management software (e.g., policy based management engine 210 of FIG. 2), determines whether the cartridge is to be reclaimed. Such an evaluation may occur at that instant, or at some definite and later period of time.

In the present embodiment, a cartridge 506 is eligible to be reclaimed under the “percent of active data” policy if the amount of data on the active data volumes currently on the cartridge relative to the full capacity of the cartridge falls below a pre-defined value (“Yes” branch of the decision block 406). The pre-defined value, for example, may be anywhere in the range from 1 to 99 percent of the storage capacity of the cartridge. When a cartridge contains an amount of inactive data, it is likely to be intermixed with active data and the efficiency of the storage for the cartridge is reduced. Reclaiming the cartridge transfers only the active data volumes to a tape cartridge 512, placing the active data volumes end to end, efficiently using the storage space on the tape cartridge 512, and at the same time, reclamation will provide an empty cartridge 506 to store new data.

In determining whether data on cartridge 506 is in need of reclamation, an actual amount of data stored on each cartridge 506 at full capacity is maintained (e.g., maintained in memory unit 204) and a current percentage of active data is calculated based on the amount of data on the current active data volumes and the actual amount of data stored when full and is compared to the pre-defined percentage (decision block 406). If the current percentage of active data on cartridge 506 is less than the pre-defined percentage, the data on cartridge 506 is eligible for reclamation, resulting in the active data volumes being moved to archival cartridge 512 (“Yes” branch of decision block 406 and operation 408). If however, the current percentage of active data on cartridge 506 is greater than or equal to the pre-defined percentage, then the data on cartridge 506 is not eligible to be reclaimed and the active data volumes remain on the cartridges 506 (“No” branch of decision block 406). In one embodiment of the present invention, the actual amount of data stored on a cartridge when the cartridge is full is recorded by storage management engine 208 in memory unit 204 whenever the storage management engine 208 fills the cartridge to capacity. However, one of ordinary skill in the art will recognize that other methods of obtaining and storing the actual amount of data stored for a cartridge can be implemented. In addition, simply using the maximum capacity for the cartridge can provide a usable value.

Once it has been determined that data of a cartridge 506 is eligible for reclamation, the data is migrated to a cartridge having the desired characteristics to store the data (operation 408). In furtherance of this, each volume with active data is copied to available space on cartridges 512 of pool 504 (operation 408). Referring to FIG. 5B, cartridge 506(2) contains enough inactive data volumes 510 such that the amount of active data on the cartridge 506(2) has fallen below the pre-defined percentage. Consequently, to improve the storage efficiency of cartridge 506(2), the active data volumes 508 are copied to data cartridge 512, placing the active data volumes end to end and allowing additional active data to be placed on the cartridge. When all active data volumes of a cartridge 506(2) have been copied, the cartridge 506(2) is eligible for use to store new data.

While the presently described embodiment of the “percent of active data” policy is described as above, one of ordinary skill in the art will recognize that the present invention can be extended. For example, the present embodiment does not limit the copying of active data volumes to only one pool 504 but may be to a number of cartridges contained in a number of pools.

Time Since Last Access Migration policy

The “time since last access” migration policy performed by policy based migration engine 210 is now described in accordance with the present invention. In the presently described example, it is desirable to manage the data in a hierarchical data storage system (e.g., system 100) to account for data needing to be accessed relatively quickly as well as data needed to be stored for a lengthy period of time. Some tape cartridge formats provide for relatively fast access of data on the cartridge, while others are designed more for long term storage of data. Generally, there are cost differences between these formats. Accordingly, data performance and cost savings can be gained by efficiently managing the data stored on the various cartridges. Accordingly, a “time since last access” migration policy is defined. In general, the “time since last access” policy addresses the management of data that, when created and for sometime thereafter, has a relatively high likelihood of being accessed by a host and for which access time is important. Accordingly, it is desirable that the data be stored initially on a cartridge having a relatively fast access time. However, at some point after the creation and writing of the data, access to the data may be less frequent. Consequently, the fast access to the data may not be desired, and the data may be transferred to a cartridge having a slower access time, and possibly lower cost. As such, the present invention allows for migration of the infrequently accessed data from cartridges 506 to cartridges 512. For clarity of explanation, the “time since last access” policy is explained in reference to FIGS. 4 and 5.

In operation, a “time since last access” policy is defined for pool 502 and as part of that definition, pool 504 is defined as the target pool. Source pool 502 contains fast access type storage cartridges, for example cartridges having a typical access time of 20 seconds or less. Target pool 504 includes archival type data cartridges, for example a cartridge capable of storing 300 GB of data or more for an extended period of time (e.g., decades). Typically, the archival type cartridges have relatively slower access times (e.g., 100 seconds). In one embodiment of the present invention, pools 502 and 504 are defined with storage management software (e.g., storage management engine 208). In accordance with the present invention, a cartridge 506 is selected (operations 402 or 412) and the policy obtained for the cartridge is the “time since last access” policy (operation 404). The policy based management software (e.g., policy based management engine 210 of FIG. 2) determines whether the cartridge is to be reclaimed. In the present embodiment, a cartridge 506 is eligible to be reclaimed under the “time since last access” policy if a pre-defined period of time has elapsed since any data on the cartridge has been accessed (“Yes” branch of the decision block 406). The pre-defined period of time, for example, can be anywhere in the range from 1 to 365 days. One of ordinary skill in the art will recognize that minutes, hours or other methods of measuring time can be used. Reclaiming the cartridge results in the transfer of active data volumes to a tape cartridge 512 more suitable to archival of data rather than providing fast access time, and at the same time, reclamation will provide an empty cartridge 506 to store new data which is frequently accessed.

In determining whether data on cartridge 506 is in need of reclamation, an actual last access time to data on each cartridge 506 is maintained (e.g., in memory unit 204) and the difference between the current time and the actual last access time is compared to the pre-defined period of time (decision block 406). If the difference between the current time and the actual last access time for cartridge 506 is greater than or equal to the pre-defined period of time, the data on cartridge 506 is not frequently accessed and is eligible to be reclaimed, resulting in the active data volumes being moved to archival cartridge 512 (“Yes” branch of decision block 406 and operation 408). If however, the difference between the current time and the actual access time for cartridge 506 is less than the pre-defined period of time, then the data on cartridge 506 is considered frequently accessed and is not eligible to be reclaimed and the active data volumes remain on the fast access cartridges (“No” branch of decision block 406). In one embodiment of the present invention, the actual last access time is recorded by storage management engine 208 in memory unit 204 whenever a host 102 accesses data on cartridges 506. However, one of ordinary skill in the art will recognize that other methods of obtaining and storing the last access time of a cartridge can be implemented. In addition, last access times for the individual volumes stored on the cartridge 506 could also be stored and used in determining if the cartridge is eligible for reclaim.

Once it has been determined that data of a cartridge 506 is eligible for reclamation, the data is migrated to a cartridge having the desired characteristics to store the data (operation 408). In furtherance of this, each volume with active data is copied to available space on cartridges 512 of pool 504 (operation 408). Referring to FIG. 5B, it is determined that the data on cartridge 506(2) is infrequently accessed. Consequently, to improve the storage performance of cartridge 506(2), the active data volumes 508 are copied to data cartridge 512, designed for long term storage of data without consideration for fast access time. When all active data volumes of a cartridge 506(2) have been copied, the cartridge 506(2) is eligible for use to store new data for which fast access is an important factor.

While the presently described embodiment of the “time since last access” policy is described as above, one of ordinary skill in the art will recognize that the present invention can be extended. For example, the present embodiment can be extended to cover the identification and copying of individual volumes from cartridges 506 to cartridges 512. Additionally, copying is not limited to targets of one pool 504 but may be to a number of cartridges contained in a number of pools.

Time Since Last Data Written Migration Policy

It is desirable to manage the long time archival of data in a hierarchical data storage system (e.g., system 100). Accordingly, a “time since last data written” migration policy performed by policy based migration engine 210 is described in accordance with the present invention. In general, the “time since last data written” policy addresses the management of data that was written to cartridge 506 for long term retention. However, cartridges having improved storage capacity, improved retention time, less cost, and the like may be introduced into the market. Consequently, it would be advantageous to migrate the data from the older technology cartridges to cartridges of newer technology. In the least, the migration would improve the reliability of the storage of data within the hierarchical data storage system, while possibly decreasing the total cost of ownership of the system at the same time. For clarity of explanation, the “time since last data written” policy is described with reference to FIGS. 4 and 5.

In operation, pools 502 and 504 are defined as the source and target pools, respectively for the “time since last data written” policy. Source pool 502 contains cartridges designed for long term storage of data, for example IBM 3590 model E1A K media cartridges. Target pool 504 includes cartridges having improved long term storage characteristics as compared to cartridges 506, for example IBM 3592 model J1A JA media cartridges. In one embodiment of the present invention, pools 502 and 504 are defined with storage management software (e.g., storage management engine 208). In accordance with the present invention, a cartridge 506 of pool 502 is selected (operations 402 or 412) and the policy obtained for the cartridge is the “time since last written” policy (operation 404). The policy based management software (e.g., policy based management engine 210 of FIG. 2) determines whether the cartridge is to be reclaimed. In the present embodiment, cartridge 506 is reclaimed under the “time since last data written” policy if a pre-defined period of time has elapsed since any data was written to the cartridge. The pre-defined period of time, for example, can be anywhere in the range from 1-365 days. One of ordinary skill in the art will recognize that seconds, minutes or other methods of measuring time could be used. Reclaiming the cartridge results in the transfer of active data volumes to a tape cartridge 512 having improved archival properties. Subsequently, cartridges 512 can replace cartridge 506 for the archival of data and cartridge 506 can be removed from the library.

In determining whether data on cartridge 506 is in need of reclamation, an actual time since last data written to each cartridge 506 is maintained (e.g., in memory unit 204) and the difference between the current time and the actual last time since data written time is compared to the pre-defined period of time (decision block 406). If the pre-defined period of time has elapsed since the last data was written to cartridge 506, it is assumed that long term storage of the volume is desired and, consequently, the active data volumes on cartridge 506 should be stored on cartridges having preferable long term storage characteristics (“Yes” branch of decision block 406 and operation 408). If however, the pre-defined period of time has not elapsed since the last data was written to cartridge 506, then it is not necessary to transfer the active data volumes on cartridge 506 to another cartridge. In one embodiment of the present invention, the actual time since last data written is recorded by storage management engine 208 in memory unit 204 whenever a host 102 writes data on cartridge 506. However, one of ordinary skill in the art will recognize that other methods of obtaining and storing the last since last data written of a volume can be implemented. In addition, the time when data was last written for the individual volumes stored on the cartridge 506 could also be stored and used in determining if the cartridge is eligible for reclaim.

Referring to FIG. 5B, once it has been determined that data of cartridge 506(2) is eligible for reclamation, the data is migrated (operation 408). In operation, the active data volumes are copied to available space on cartridges 512 of pool 504 (operation 408). In the presently described embodiment, it is determined that a pre-defined period of time has elapsed since any data to cartridge 506(2) was written, and consequently, all active data volumes 508 are copied to data cartridge 512, having improved long term storage characteristics.

When all active data volumes of cartridge 506(2) have been copied, the cartridge 506(2) will be eligible for use to store new data or can be removed from the library. In one embodiment of the present invention, the policy based migration software examines pool 502 at a time initiated by a user (e.g., upon the installation of tape drives and tape cartridges having improved storage characteristics the user will want to migrate the data from the older cartridges to the newer cartridges, and use the new cartridges for long term storage).

While the presently described embodiment of a “time since last data written” migration policy is described as above, one of ordinary skill in the art will recognize that the present invention can be extended. For example, the present embodiment can be extended to cover the identification and copying of a single active data volume from cartridges 506 to cartridges 512. Additionally, copying is not limited to targets of one pool 504 but may be to a number of cartridges contained in a number of pools.

Rate of Expiration of Data Migration Policy

The “rate of expiration of data” migration policy performed by policy based migration engine 210 is now described in accordance with the present invention. For aid in explanation of the policy, the following description refers to FIGS. 4 and 5.

In the presently describe example, it is desirable to maximize the storage efficiency of data cartridges 506 of the system (e.g., system 100). Accordingly, a “rate of expiration of data” migration policy is defined. In general, the “rate of expiration of data” policy addresses the management of data intended for long term storage but initially written to a data cartridge that also has short term storage data written on it. For example, some of the data volumes 508 on cartridges 506 contain short term type data that generally expires a few weeks after being written. However, it is often the case that other data volumes which must be stored longer than a few weeks may also be written to cartridge 506. If most of the data volumes are of the short term storage type, the data generally expires within a few weeks, and the cartridge is reclaimed and used for additional short term storage. However, when using a migration policy such as “percent of active data”, the presence of the long term data volumes can prevent the reclamation of the cartridge until a portion of the long term data has expired as well. Consequently, it is advantageous to reclaim cartridges with long term storage data written on them after the short term storage data has expired, so the storage space of the cartridges can be reclaimed and the cartridges can be reused.

In operation, pools 502 and 504 are defined as the source and target pools, respectively with a “rate of expiration of data” policy. Source pool 502 contains cartridges designed for long term storage of data, for example IBM 3590 model E1A K media cartridges. Target pool 504 includes cartridges 512 having improved long term storage characteristics as compared to cartridges 506. In one embodiment of the present invention, pools 502 and 504 are defined with storage management software (e.g., storage management engine 208). In accordance with the present invention, a cartridge 506 of pool 502 is selected (operations 402 or 412) and the policy obtained for the cartridges is the “rate of expiration of data” policy. The policy based management software (e.g., policy based management engine 210 of FIG. 2) determines whether the cartridge is to be reclaimed. In the present embodiment, a cartridge 506 is eligible to be reclaimed under the “rate of expiration of data” policy if a pre-defined period of time has elapsed since any data volume on the cartridge became expired (“Yes” branch of decision block 406). As used herein, a data volume becomes expired when the data stored on it has been expired by a host. The pre-defined period of time can be anywhere in the range from 1-365 days. One of ordinary skill in the art will recognize that seconds, minutes or other methods of measuring time could be used. Reclaiming the cartridge will transfer the active data volumes to a tape cartridge 512 having improved archival properties. Subsequently, cartridge 512 replaces cartridge 506 for the archival of data, and at the same time, cartridge 506 is now empty and can be used to store new data.

In determining whether data on cartridge 506 is in need of reclamation, an actual last time of expiration for each cartridge 506 is maintained (in memory unit 204 for example). If the pre-defined time set by the user has elapsed since the actual last expiration time, the cartridge 506 is eligible for reclaim (“Yes” branch of decision block 406). If however, the pre-defined time has not elapsed since the actual last expiration time for the cartridge 506, then the cartridge 506 is not eligible for reclaim. In one embodiment of the present invention, the actual last time of expiration is recorded by storage management engine 208 in storage unit 204 whenever a host 102 expired the data associated with one of the volumes 510 on cartridge 506. However, one of ordinary skill in the art will recognize that other methods of obtaining and storing the last time data associated with the cartridge was expired can be implemented.

Once it has been determined that data of a cartridge 506 is eligible for reclamation, the data is migrated (operation 408). In furtherance of this, each volume having active data is copied to available space on cartridges 512 of pool 504 (operation 408). Referring to FIG. 5B, it is determined that all of the short term type data volumes of cartridge 506(2) have expired because the pre-defined time set is greater than the expiration cycle of short term type data and that pre-defined time has elapsed since any volume on the cartridge has been expired. Consequently, the active data volumes 508 are copied to data cartridges 512, designed for long term storage of data.

When all active data volumes of a cartridge 506(2) have been copied, the cartridge 506(2) will be eligible for use to store new data. In another embodiment of the present invention, in addition to determining if the pre-defined time period has elapsed since the last expiration of data on the cartridge, the amount of active data remaining on the cartridge 506(2) can be considered in the determination if the cartridge is eligible for reclamation. It is preferable that the active data on a cartridge 506 fall below the pre-defined threshold and that the pre-defined time has elapsed since data on the cartridge was expired for the cartridge to be reclaimed. This is preferable to prevent a cartridge from being needlessly reclaimed repeatedly when it contains only long term data.

While the presently described embodiment of the “rate of expiration of data” policy is described as above, one of ordinary skill in the art will recognize that the present invention can be extended. For example, the present embodiment can be extended to include expiration of records or groups of records of data or the identification and copying of a single active data volume from cartridges 506 to cartridges 512. Additionally, copying is not limited to targets of one pool 504 but may be to a number of cartridges contained in a number of pools.

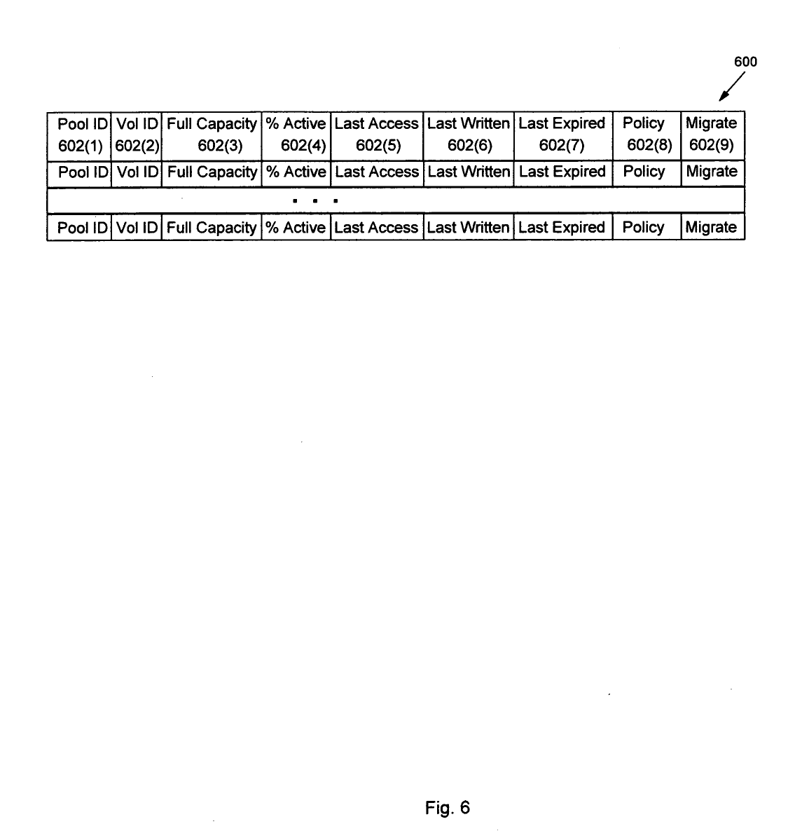

While the descriptions above have been provided in relation to the examination of cartridges and data on cartridges, other techniques of evaluating data for reclaim may be used. For example, the relevant data associated with the cartridges may be stored as records in a database. Such an exemplary database is described below with reference to FIG. 6.

Exemplary Database

FIG. 6 illustrates an exemplary database 600 used for storing information used in accordance with the present invention. Database 600, stored in memory unit 204, includes fields 602 which identify characteristics associated with volumes of a particular cartridge assigned to a particular pool. Pool ID field 602(1) identifies the pool to which the volume in Vol ID field 602(2) is assigned. Vol ID field 602(2) identifies a particular volume of data stored on a storage media (e.g., a tape cartridge in the presently described embodiment). In the presently described embodiment the Vol ID field 602(2) includes a combination of the volume number and a unique serial number which identifies the cartridge on which the volume is stored (this combination is referred to a volser). Full Capacity field 602(3) identifies the full capacity of the cartridge (e.g., the amount of data the cartridge is capable of storing). Percent of Active Data field 602(4) identifies the percentage of active data on the cartridge. Last Access field 602(5) identifies the time any data on the volume in Vol ID field 602(2) was last accessed. Last Written field 602(6) identifies the time any data to the volume in Vol ID field 602(2) was written to the cartridge. Last Expired field 602(7) identifies the time a host expired (if at all) any data on the volume identified by Vol ID field 602(2). Policy field 602(8) identifies the data migration policy associated with the Vol ID field 602(2). In the presently described embodiment, Policy field 602(8) is assigned by associating the policy with a pool. Cartridges (and volumes) which are assigned to the pool thus become subject to the policy. Migration field 602(9) indicates whether or not the conditions of the policy of Policy field 602(8) have been satisfied such that the volume of Vol ID field 602(2) is to be migrated.

In operation (e.g., of the techniques described in FIG. 4), policy based migration engine need only scan fields 602 of database 600 to determine the volumes to migrate. At each occurrence, or at some later time, the particular volumes may then be migrated. Advantages of this implementation are the speed at which the policies may be evaluated, and that such techniques may be performed without impacting the host application. One of ordinary skill in the art will recognize that the values for fields 602 may be represented any number of ways, including combining fields and separating fields. Further, the fields may be present in a single database or in separate databases or files where an application may use a database key to associate particular fields with one another.

Combination of Policies

While the presently described embodiment of each of the policies, “percent of active data”, “time since last access”, “time since last data written” and “rate of expiration of data” are described individually, one of ordinary skill in the art will recognize that in examining a cartridge 506 to determine its eligibility for reclaim, a combination of the policies can be used. For example, a cartridge 506 could be evaluated for both the “percent of active data” and “time since last data written” policies and if either criterion for reclaim is satisfied, the cartridge 506 would be reclaimed. In addition, instead of examining each cartridge and reclaiming it if eligible, the examination could be done separate and apart from the actual reclamation, resulting in a list of cartridges to be reclaimed. The reclaim step could further determine the order in which the volumes are reclaimed based on criteria such as reclaiming first those cartridges that have the smallest amount of active data on them to move, and/or first reclaiming cartridges of a type that are needed to store new data, and/or first reclaiming cartridges of a type which contain data having a high level of priority and importance. Furthermore, the migration of data is not limited to tape cartridges but may also include the migration of data from a tape cartridge to another storage device such as DASD, optical media, flash memory, combinations thereof, and the like. Moreover, while the present invention has been described with respect to a VTS system, one of ordinary skill in the art will recognize that the present invention can be implemented in other systems, including an automated tape library.

What is claimed is:

1. A data storage system comprising:
a processor;
a host interface coupled to said processor; and
a memory unit coupled to said processor, wherein said memory unit comprises:
a storage management engine; and
a policy based migration engine configured to:
determine whether data stored on a first removable storage media satisfies a migration condition of a migration policy, and, if said migration condition is satisfied, cause said data to be migrated to a second removable storage media.

2. The data storage system of claim 1, wherein said policy based migration engine is further configured to:
for each volume of data stored on said first removable storage media, determine if said volume of data satisfies said migration condition.

3. The data storage system of claim 2, wherein said migration policy is at least one of:
a percent of active data migration policy;
a time since last access migration policy;
a time since last data written migration policy; and
a rate of expiration of data migration policy.

4. The data storage system of claim of claim 3, wherein said migration condition of said time since last access migration policy comprises:
if a pre-defined period of time has elapsed since said volume was accessed, said volume is migrated from said first removable storage media to said second removable storage media.

5. The data storage system of claim 3, wherein said migration condition of said time since last data written migration policy comprises:
if a pre-defined period of time has elapsed since data corresponding to said volume was last written on the first removable storage media, said volume is migrated from said first removable storage media to said second removable storage media.

6. The data storage system of claim 3, wherein said migration condition of said rate of expiration of data migration policy comprises:
if a pre-defined period of time has elapsed since a portion of said volume has expired on said first removable storage media, said volume is migrated from said first removable storage media to said second removable storage media.

7. The data storage system of claim 6, wherein said migration condition of said rate of expiration of said data migration policy further comprises:
active data is migrated from said first removable storage media to said second removable storage media if an amount of active data stored on the cartridge is below a pre-defined threshold of active data.

8. The data storage system of claim 3, wherein said migration condition of said percent of active data policy comprises:
if an amount of active data stored on the cartridge is below a pre-defined threshhold of active data, said active data is migrated from said first removable storage media to said second removable storage media.

9. The data storage system of claim 2, wherein said policy based migration engine is further configured to:
define a first pool, said first pool including said first removable storage media; and
define a second pool, said second pool including said second removable storage media.

10. The data storage system of claim 9, wherein said determining comprises:
determining whether data associated with said first pool satisfies said migration condition,
and, if said migration condition is satisfied, cause said data to be migrated to said second pool.

11. The data storage system of claim 9, wherein a process of reclamation is used to migrate said volume from said first removable storage media to said second removable storage media.

12. The data storage system of claim 1, further comprising:
a storage unit coupled to a storage unit interface of said data storage system.

13. The data storage system of claim 1, further comprising:
a database stored in said memory unit, said database including a volume id and a migration policy, wherein said policy based migration engine is configured to analyze said database to determine whether data stored on a first removable storage media satisfies a migration condition of a migration policy.

14. A method of configuring a hierarchical data storage system for conditional data migration, comprising:
accessing a policy based migration engine of said hierarchical data storage system;
selecting a migration policy, said migration policy configured to conditionally copy active data from a first removable storage media to a second removable storage media; and
setting at least one conditional parameter for said migration policy.

15. The method of claim 14, wherein accessing said policy based migration engine comprises:
loading into memory a plurality of computer instructions configured to evaluate said at least one conditional parameter; and
if said conditional parameter is satisfied, said plurality of computer instructions are configured to cause said active data to be copied from said first removable storage media to said second removable storage media.

16. The method of claim 14, wherein said selecting comprises selecting at least one of:
a percent of active data migration policy;
a time since last access migration policy;
a time since last data written migration policy; and
a rate of expiration of data migration policy.

17. The method of claim 16, wherein setting said at least one conditional parameter for said migration policy comprises:
providing to said policy based migration engine a value representing an amount of active data stored on said first removable storage media as a percentage of all data stored on said first removable storage media.

18. The method of claim 16, wherein setting said at least one conditional parameter for said time since last access migration policy comprises:
providing to said policy based migration engine a value representing a period of time, wherein data on said first removable storage media is migrated if said data is not accessed with said period of time.

19. The method of claim 16, wherein setting said at least one conditional parameter for said time since last data written migration policy comprises:
providing to said policy based migration engine a value representing a period of time, wherein data on said first removable storage media is migrated if data has not been written to said first removable storage media with said period of time.

20. The method of claim 16, wherein setting said at least one conditional parameter for said rate of expiration of data migration policy comprises:
providing to said policy based migration engine a value representing a period of time, wherein data on said first removable storage media is migrated if said period of time has elapsed since a portion of said data became expired.

21. The method of claim 14, further comprising:
defining a first pool, said first pool including said first removable storage media;
defining a second pool, said second pool including said second removable storage media;
assigning said migration policy to said first pool; and
if said conditional parameter is satisfied, said plurality of computer instructions are configured to cause said active data to be copied from said first pool to said second pool.

22. A tape library comprising:
a processor;
a plurality of removable storage media, including a first removable storage media and a second removable storage media;
a tape drive;
a plurality of storage bins;
a means for moving said removable storage media between said storage bins and said tape drive;
a host interface coupled to said processor; and
a memory unit coupled to said processor, wherein said memory unit comprises:
a storage management engine; and
a policy based migration engine configured to:
determine whether data stored on a first removable storage media satisfies a migration condition of a migration policy,
and, if said migration condition is satisfied, cause said data to be migrated to a second removable storage media.

23. The tape library of claim 22, further comprising:
a library manager interface coupled to said processor;
a storage unit interface coupled to said processor; and
a control unit, wherein said control unit comprises said memory unit.

24. The tape library of claim 23, wherein said policy based migration engine is further configured to:
for each volume of data on said first removable storage media, determine if said volume of data satisfies said migration condition.

25. The tape library of claim 24, wherein said migration policy includes at least one of:
a percent of active data migration policy;
a time since last access migration policy;
a time since last data written migration policy; and
a rate of expiration of data migration policy.

26. The tape library of claim of claim 25, wherein said migration condition of the time since last access migration policy comprises:
if a pre-defined period of time has elapsed since said volume was accessed, said volume is migrated from said first removable storage media to said second removable storage media.

27. The tape library of claim 25, wherein said migration condition of said time since last data written migration policy comprises:
if a pre-defined period of time has elapsed since data corresponding to said volume was last written on the first removable storage media, said volume is migrated from said first removable storage media to said second removable storage media.

28. The tape library of claim 25, wherein said migration condition of said rate of expiration of data migration policy comprises:
if a pre-defined period of time has elapsed since a portion of said volume has expired on said first removable storage media, said volume is migrated from said first removable storage media to said second removable storage media.

29. The tape library of claim 28, wherein said migration condition of said rate of expiration of said data migration policy further comprises:
active data is migrated from said first removable storage media to said second removable storage media if an amount of active data stored on the cartridge is below a pre-defined threshold of active data.

30. The tape library of claim 25, wherein said policy based migration engine is further configured to:
define a first pool, said first pool including said first removable storage media; and
define a second pool, said second pool including said second removable storage media.

31. The tape library of claim 29, wherein a process of reclamation is used to migrate said volume from said first removable storage media to said second removable storage media.

32. The tape library of claim 22, further comprising:
a storage unit coupled to a storage unit interface of said tape library.

33. The tape library of claim 22, wherein said first removable media is a tape cartridge.

34. A method of migrating data from a first tape cartridge to a second tape cartridge, comprising:
obtaining a migration policy, said migration policy having a migration condition;
determining whether at least one volume on said first tape cartridge satisfies said migration condition; and
if said migration condition is satisfied, copying said at least one volume to said second tape cartridge.

35. The method of claim 34, wherein a hierarchical data storage system includes a plurality of tape cartridges including said first tape cartridge and said second tape cartridge, said method further comprising:
defining a first pool of tape cartridges;
defining a second pool of tape cartridges;
assigning said migration policy to said first pool;
determining whether each volume on each tape cartridge in said first pool satisfies said migration condition; and
if said migration condition is satisfied, copying said volume to at least one cartridge in said second pool.

36. The method of claim 35, wherein said steps are performed as a background process of the hierarchical data storage system.

37. The method of claim of claim 35, wherein said determining step comprises:
determining if a pre-defined period of time has elapsed since said volume has been accessed on said first tape cartridge.

38. The method of claim 35, wherein said determining step comprises:
determining if a pre-defined period of time has elapsed since a portion of said volume has expired on said first tape cartridge.

39. The method of claim 38, wherein said determining step further comprises:
determining if an amount of active data stored on the cartridge is below a pre-defined threshold of active data.

40. The method of claim 35, wherein said determining step comprises:
determining if a pre-defined period of time has elapsed since data corresponding to said volume was last written on said first tape cartridge.

41. The method of claim of claim 35, wherein said determining step comprises:
determining if a pre-defined period of time has elapsed since said volume has been accessed on said first tape cartridge;
determining if a pre-defined period of time has elapsed since data corresponding to said volume was last written on said first tape cartridge; and
determining if a pre-defined period of time has elapsed since a portion of said volume has expired on said first tape cartridge.

42. The method of claim 35, wherein said steps are performed so as to be transparent to a host application utilizing storage on said hierarchical data storage system.

43. The method of claim 35, wherein said determining step comprises:
determining whether each active volume on each tape cartridge in said first pool satisfies said migration condition.

44. A computer program product tangibly embodying a program of machine-readable instructions executable by a processor of a hierarchical data storage system to perform a method of migrating data from a first tape cartridge to a second tape cartridge, the method comprising operations of:
obtaining a migration policy, said migration policy having a migration condition;
determining whether at least one volume on said first tape cartridge satisfies said migration condition; and
if said migration condition is satisfied, copying said at least one volume to said second tape cartridge.

45. The computer program product of claim 44, wherein said hierarchical data storage system includes a plurality of tape cartridges including said first tape cartridge and said second tape cartridge, said method further comprising:
defining a first pool of tape cartridges;
defining a second pool of tape cartridges;
assigning said migration policy to said first pool;
determining whether each volume on each tape cartridge in said first pool satisfies said migration condition; and
if said migration condition is satisfied, copying said volume to at least one cartridge in said second pool.

46. The computer program product of claim 45, wherein said steps are performed as a background process of the hierarchical data storage system.

47. The computer program product of claim of claim 45, wherein said determining step comprises:
determining if a pre-defined period of time has elapsed since said volume has been accessed on said first tape cartridge.

48. The computer program product of claim 45, wherein said determining step comprises:
determining if a pre-defined period of time has elapsed since a portion of said volume has expired on said first tape cartridge.

49. The computer program product of claim 48, wherein said determining step further comprises:
determining if the amount of active data stored on the cartridge is below a pre-defined threshold of active data.

50. The computer program product of claim 45, wherein said determining step comprises:
determining if a pre-defined period of time has elapsed since data corresponding to said volume was last written on said first tape cartridge.

51. The computer program product of claim of claim 45, wherein said determining step comprises:
determining if a pre-defined period of time has elapsed since said volume has been accessed on said first tape cartridge;
determining if a pre-defined period of time has elapsed since data corresponding to said volume was last written on said first tape cartridge; and
determining if a pre-defined period of time has elapsed since a portion of said volume has expired on said first tape cartridge.

52. The computer program product of claim 45, wherein said steps are performed so as to be transparent to a host application utilizing storage on said hierarchical data storage system.

53. The computer program product of claim 45, wherein said determining step comprises:
determining whether each active volume on each tape cartridge in said first pool satisfies said migration condition.

54. The computer program product of claim 45, wherein said instructions are embodied on a storage device of said hierarchical data storage system.

55. A method of migrating data from a plurality of storage devices, comprising:
defining a first logical group containing said plurality of storage devices;
obtaining a migration policy, said migration policy having a migration condition;
determining whether at least one portion of data on said first storage device satisfies said migration condition, wherein said determining comprises at least one of:
determining if a pre-defined period of time has elapsed since said volume has been accessed on said first tape cartridge;
determining if a pre-defined period of time has elapsed since data corresponding to said volume was last written on said first tape cartridge;
determining if a pre-defined period of time has elapsed since a portion of said volume has expired on said first tape cartridge; and
if said migration condition is satisfied, copying said at least one portion of data to a destination storage device.
